(19) United States
(12) Patent Application Publication
(10) Pub. No.: US 2026/0310576 A1
(43) Pub. Date: Oct. 8, 2026

(54) METHOD FOR APPLICATION PERFORMANCE PREDICTION

(71) Applicant: TELEFONAKTIEBOLAGET LM ERICSSON (PUBL), Stockholm (SE)

(72) Inventors: Fetahi WUHIB, Pincourt (CA); Dániel GÉHBERGER, Montreal (CA)

(73) Assignee: TELEFONAKTIEBOLAGET LM ERICSSON (PUBL), Stockholm (SE)

(21) Appl. No.: 19/482,774

(22) PCT Filed: May 16, 2023
(86) PCT No.: PCT/IB2023/055038

§ 371 Date: Nov. 9, 2025

(51) Int. Cl. G06F 11/3604

(52) U.S. Cl. CPC G06F 11/3608

(57) ABSTRACT

The disclosure relates to a method, and apparatus for application performance prediction. The method comprises measuring hardware performances of subroutines of a plurality of benchmarking applications executed on a plurality of hardware flavors. The method comprises generating hardware performance profiles for the subroutines, each hardware performance profile being associated with a subroutine, a hardware flavor and a measured hardware performance. The method comprises receiving a performance prediction request for an application. The method comprises predicting the application performance on at least one hardware flavor, based on the hardware performance profiles corresponding to a plurality of subroutines of the application. The method comprises providing the performance prediction for the application on each of the at least one hardware flavor.

### TECHNICAL FIELD

The present disclosure relates to hardware selection based on an application performance prediction.

### BACKGROUND

Application execution performance is one of the key metrics in computing systems. Performance depends heavily on the underlying hardware setup, let it be different central processing units (CPUs) from different vendors, different CPU types from the same vendor or CPUs combined with accelerators. With the introduction of cloud and especially edge cloud, available hardware setups for a given deployment may vary, making application performance understanding and prediction important tasks.

Accelerators are being used for more and more purposes nowadays both in the wide industry as well as in the telecommunications industry. Due to the high amount of data to be processed in a short time in many use-cases, different accelerators are involved to speed up entire applications or critical parts of applications. Graphics processing units (GPUs) are probably the most well-known accelerators today that are used to speed up workloads using their massively parallel architecture. Other accelerators include for example field programmable gate arrays (FPGAs) that enable dynamically synthetizing computation logic onto programmable hardware. Further, custom application-specific integrated circuits (ASICs) that are being built for machine learning, such as tensor processing units (TPUs), or fifth generation (5G) physical layer acceleration can also be considered. These devices can serve a single purpose quite efficiently.

Selecting an accelerator for a workload typically requires deep understanding of both the workload along with the benefits and drawbacks of the different types of accelerators. To take an example, a workload that can be executed in parallel on some input data might suit a GPU well, however, if the requirements or parallelism is not that high, CPU vector extensions (e.g., x86 streaming single instruction multiple data (SIMD) extensions (SSE), advanced vector extension (AVX)) might do an excellent job without putting GPU as a requirement. As another example, a workload that involves more serial tasks that can be pipelined might fit an FPGA better.

Supporting multiple architectures and multiple accelerators for a single application is a challenging task. When using low-level programming abstractions (e.g., direct coding in C++, compute unified device architecture (CUDA) for GPU), the developers might need to maintain multiple implementations of functions. Some platforms such as the Intel® OneAPI or OpenCL™ enable running the same code over multiple targets. Turning to higher level libraries or frameworks such as TensorFlow for machine learning, the task gets simpler since the developers of the libraries or frameworks have done the optimization.

When automatically selecting one of the available hardware devices to execute an application, there are two main approaches in the literature. The first approach relies on performance metrics collected by executing the applications. For example, the authors in (M. Joselli et al., “Automatic dynamic task distribution between CPU and GPU for real-time systems”, 2008 11th IEEE International Conference on Computational Science and Engineering, 2008, pp. 48-55) proposed multiple schemas to automatically select either CPU or GPU to run the offloadable parts of applications. The key idea was to run these functions using a subset of the dataset on both CPU and GPU, measure the execution time, and then select the faster compute resource to run with the complete dataset.

The second approach uses performance prediction based on low-level application features to decide where to execute applications. For instance, the authors in (K. Hoste, A. Phansalkar, L. Eeckhout, A. Georges, L. K. John, and K. De Bosschere, “Performance prediction based on inherent program similarity”, 2006 International Conference on Parallel Architectures and Compilation Techniques (PACT), September 2006, pp. 114-122) use microarchitecture-independent characteristics of the application to predict its performance on a specific compute node. The microarchitecture characteristics are measured by running an instrumented binary of the application, which is generated using an instrumenting tool. The measured characteristics are related to the characteristics of the previously profiled programs from a benchmark suite. Then based on the similarity of the application of interest with those programs, predicting the performance of the application of interest can be performed.

Another example is presented in (A. Hayashi, K. Ishizaki, G. Koblents, and V. Sarkar, “Machine-Learning-based Performance Heuristics for Runtime CPU/GPU Selection”, 15: Proceedings of the Principles and Practices of Programming on The Java Platform, Melbourne, FL, USA, September 2015, pp. 27-36) and (U.S. Pat. No. 10,540,194B2 to G. Koblents, A. S. Housfater, K. Ishizaki, and A. Hayashi, “Runtime GPU/CPU selection”, Jan. 21, 2020). There, the authors extend the functionalities of JAVA just-in-time (JIT) compiler and runtime capabilities to automatically select a preferred computing resource (either CPU or GPU). This is achieved by collecting features from compiler and then using a binary prediction model to decide which hardware to select.

Moreover, the approach presented in (D. Grewe and M. F. P. O'Boyle, “A Static Task Partitioning Approach for Heterogeneous Systems Using OpenCL”, International Conference on Compiler Construction, Berlin, Heidelberg, 2011, pp. 286-305) analyzes the application code and extract application features, such as the number of floating-point instructions, by analyzing the abstract syntax tree generated by the compiler. These features are used by the machine learning model (support vector machines) to decide where to execute (parts of) the application.

### SUMMARY

The solutions described above have several shortcomings and do not provide automated deployment and configuration of hardware-accelerated applications. For instance, none of the solutions provide a mechanism to select the compute node, where the application will be deployed, from a set of heterogeneous nodes.

Herein, a solution is proposed that can be used to predict the performance of an application for different hardware flavors based on a function call trace on a single hardware flavor and offline created function call traces of one or more benchmarking applications on the given hardware flavors.

The solution includes the identification of subroutines in applications based on the traces. This first enables calculating hardware flavor related performance ratios (speedup/slowdown) for individual subroutines in benchmark applications. Second, after finding common subroutines between benchmark applications and a new application, performance can be predicted using the determined performance ratios for unknown hardware flavors.

There is provided a computer implemented method for application performance prediction. The method comprises measuring hardware performances of subroutines of a plurality of benchmarking applications executed on a plurality of hardware flavors. The method comprises generating hardware performance profiles for the subroutines, each hardware performance profile being associated with a subroutine, a hardware flavor and a measured hardware performance. The method comprises receiving a performance prediction request for an application. The method comprises predicting the application performance on at least one hardware flavor, based on the hardware performance profiles corresponding to a plurality of subroutines of the application. The method comprises providing the performance prediction for the application on each of the at least one hardware flavor.

There is provided an apparatus for application performance prediction. The apparatus comprises processing circuits and a memory. The memory contains instructions executable by the processing circuits whereby the apparatus is operative to measure hardware performances of subroutines of a plurality of benchmarking applications executed on a plurality of hardware flavors. The apparatus is operative to generate hardware performance profiles for the subroutines, each hardware performance profile being associated with a subroutine, a hardware flavor and a measured hardware performance. The apparatus is operative to receive a performance prediction request for an application. The apparatus is operative to predict the application performance on at least one hardware flavor, based on the hardware performance profiles corresponding to a plurality of subroutines of the application. The apparatus is operative to provide the performance prediction for the application on each of the at least one hardware flavor.

There is provided a non-transitory computer readable media having stored thereon instructions for application performance prediction. The instructions comprise measuring hardware performances of subroutines of a plurality of benchmarking applications executed on a plurality of hardware flavors. The instructions comprise generating hardware performance profiles for the subroutines, each hardware performance profile being associated with a subroutine, a hardware flavor and a measured hardware performance. The instructions comprise receiving a performance prediction request for an application. The instructions comprise predicting the application performance on at least one hardware flavor, based on the hardware performance profiles corresponding to a plurality of subroutines of the application. The instructions comprise providing the performance prediction for the application on each of the at least one hardware flavor.

The method and apparatus provided herein present improvements to the way application performance prediction operate.

The solution enables predicting the performance of applications on hardware flavors without actual execution. This can highly speed up and optimize hardware flavor selection. Compared to existing solutions, the solution presented herein takes into account execution flows, and is thus able to represent actual execution times in light of input values. Unlike existing solutions based on source code analysis, the technique presented herein is able to pinpoint and include relevant library functions without requiring source-code availability.

### BRIEF DESCRIPTION OF THE DRAWINGS

FIG. 1 is a schematic illustration of the application performance prediction solution.

FIG. 2 is a block diagram showing a high-level architecture of the application performance prediction solution.

FIG. 3 is a flowchart of a method for performance profile generation.

FIG. 4 is a schematic illustration of an example execution tree and identified subroutines.

FIG. 5 is a flowchart of a method for performance estimation.

FIG. 6 is a flowchart of a method for application performance prediction.

FIG. 7 is a schematic illustration of a hardware in which steps and/or method described herein can be executed.

FIG. 8 is a schematic illustration of a virtualization environment in which the different steps and hardware components described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

At least some aspects of the techniques described herein may be implemented using artificial intelligence, which comprises a variety of techniques as would be apparent to a person skilled in the art, including machine learning techniques. Machine learning techniques include neural network (NN), or artificial neural network (ANN), and both terms may be used interchangeably herein.

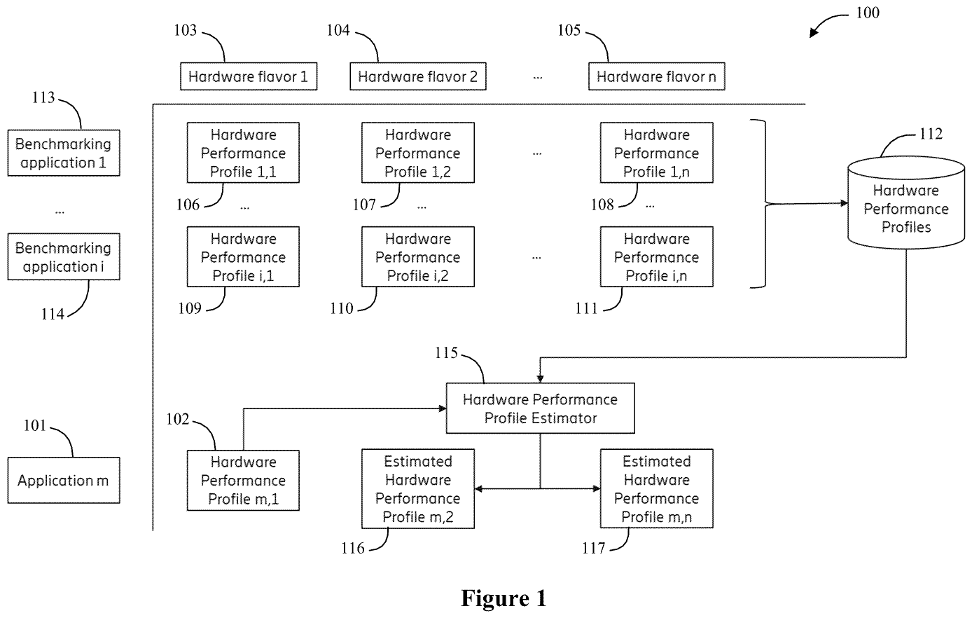

FIG. 1 shows an overview of the solution 100 presented herein. As previously mentioned, applications might be deployed on a variety of hardware platforms that will be called hardware flavors. The choice of hardware flavor might depend on availability, cost or performance considerations, for example. The solution depends on collecting hardware performance profiles for one or more benchmarking applications running on the different hardware flavors. Performance profiles are based on execution traces with timing information as will be detailed further below.

For a new application (application m 101 in the figure) the method generates a hardware performance profile 102 on at least one of the hardware flavors 103, 104, 105, in this case 103, and then the previously collected benchmark profiles 106-111, stored in storage 112, generated for benchmark applications 113, 114, are used to predict the performance of the application on other hardware flavors, 104, 105.

For the prediction to work, only one hardware performance profile, 106-111, is required for each hardware flavor 103-105, however the prediction might be more accurate with more profiles available. This also implies that if more than one benchmarking application 113, 114 is used, then it is not required that all of them be profiled on all hardware flavors 103-105.

Some hardware flavors 103-105 might use different CPU types, while others might be equipped with hardware accelerators (e.g., a specific type of GPU). The approach presented herein is generic enough to be applied to different hardware configurations, whether one or more accelerators are included or not.

The solution follows traditional machine learning paradigm whereby a performance prediction model 115, such as for example a linear regression model, a regression tree model or a neural network model, is trained offline based on collected data 112. The model is then used to perform inferencing of the performance of an application 101 on a given hardware configuration. The result being estimated hardware performance profiles 116, 117.

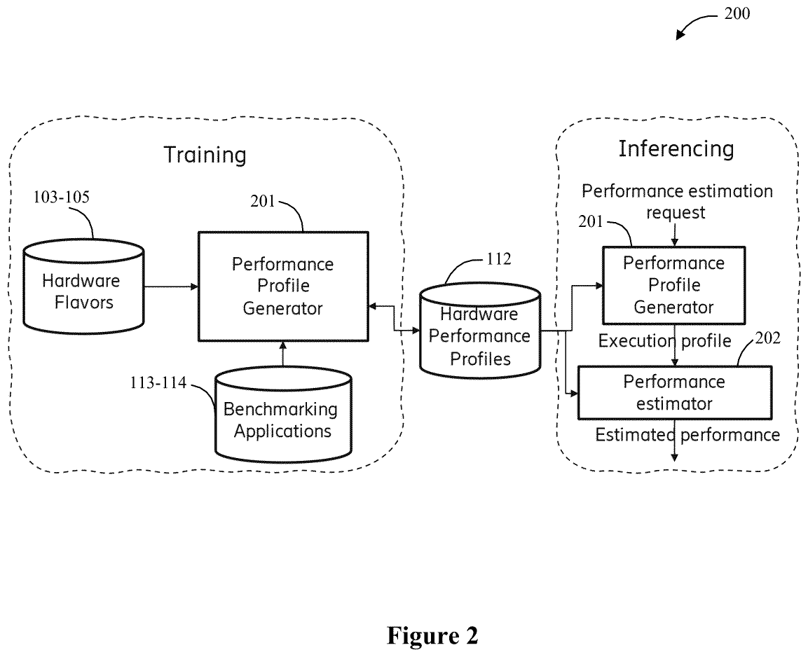

FIG. 2 shows the high-level architecture 200 of the solution. On the training side, the performance profile generator component 201 is used to profile the execution of a set of benchmarking applications 113-114 on the various hardware flavors 103-105 available. The component 201 then stores the profiles for each hardware flavor in the hardware performance profile repository 112.

The inferencing part is triggered when a request is received to estimate the performance of an application on a set of hardware flavors. When this happens, the first step is to profile the execution of that application, e.g., application 101 of FIG. 1, on one of hardware flavors 103-105 whose performance profile is stored in the repository 112. This is done using the same performance profile generator component 201. Alternatively, this step could be skipped if the application was already profiled before. Then, for each target hardware flavor a performance estimation is needed; the performance estimator component 202 produces an estimation of the application's performance by considering the application's performance on the first hardware flavor and the performance of the benchmarking applications on the first as well as the other flavors. In the following two subsections, the training and inferencing stages are described in more details.

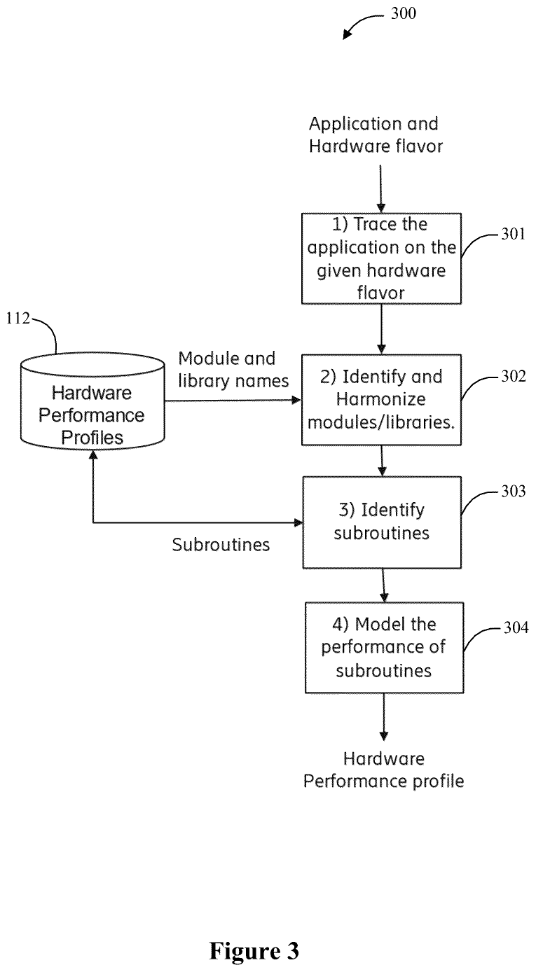

Turning to FIG. 3, the high-level steps of the method 300 executed by the performance profile generator 201, for profiling the execution of an application on a given hardware profile, are illustrated. During the training stage, the performance profiles of all benchmarking applications 106-111 (FIG. 1) are captured for each hardware flavor 103-105 (FIG. 1). The results are stored in the hardware performance profiles 112. During inference, the results are used as input to the performance estimator component 202.

FIG. 3 illustrates the technique for profiling the execution of an application on a given hardware flavor such that the result can be used to estimate the performance of the application for a different hardware flavor. The solution relies on tracing the execution of the application. The profiling process is done in 4 steps, which are described below.

The first step is the execution tracing, 301. The method starts by capturing the execution trace of the application, e.g., application 101. A generic tracer for a given programming language should be able to provide the required information.

A simple trace format is: [time_stamp, module.function, event] where:
time_stamp is a high-resolution timestamp of the event,
module.function is a unique identifier of the function called, and
event is either ‘call’ to indicate execution of the function has started or ‘return’ to indicate that the execution of the function is completed.

An example of an execution of a simple program with five functions (F1, F2, . . . , F5) may give the following trace, for example:

1.0, F1, call
2.0, F2, call
2.5, F3, call
3.0, F4, call
3.1, F4, return
4.0, F3, return
5.1, F3, call
5.5, F4, call
5.7, F4, return
5.8, F3, return
6.0, F2, return
6.3, F5, call
7.0, F5, call
7.1, F5, return
7.2, F5, return
8.0, F1, return

In the Python programming language, for instance, the function sys.settrace can be used to implement such a functionality.

The second step is the function identification, 302. In this step, the functions are identified uniquely. Depending on how and where library modules are installed across different configurations, it might be important to harmonize the different function and module names that are recorded by the tracing function. In the example above, if running the same program gives a different function (name), say F10, instead of, say F5, then this step 302 ensures that the method considers this function identical in all further processes. In Python, for instance, depending on how modules were installed (globally, locally for a user, in a virtual environment, etc.), the modules are identified with different paths. As a solution, one could opt to remove the prefix path to the different path of the modules such that they are identical. It should be noted that this step might be optional for other implementations.

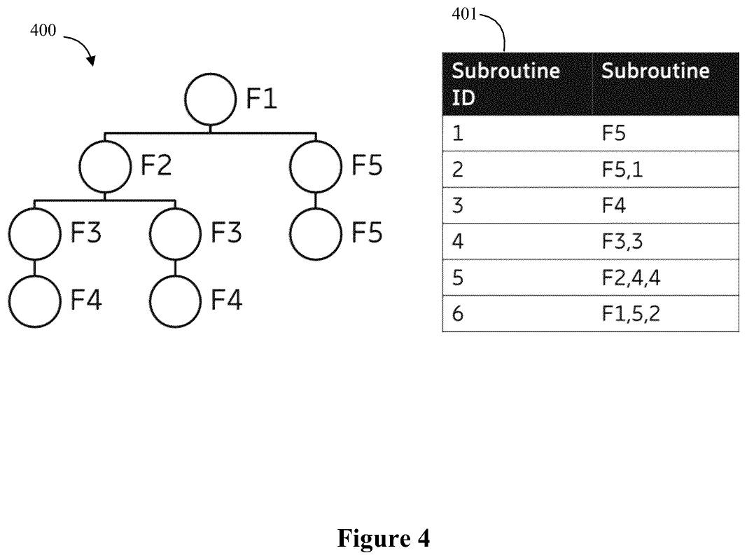

The third step is the subroutine identification, step 303. In this step, a subroutine is defined as a specific (recursive) call sequence of functions. If one imagines a so-called execution tree (i.e., a tree where nodes are functions and edges are caller/callee relationships between functions), each node of that tree represents a subroutine. The example execution tree 400, illustrated in FIG. 4, shows the tree for the trace provided above. Each node in this tree represents a subroutine. A subroutine could include anything from one function (e.g., F4 and F5) to several thousands of functions. Subroutines can also be compactly represented by specifying subroutines in terms of other subroutines. Such representation is shown in the table 401 illustrated in FIG. 4. In this example, if a subroutine identifier (ID) of 3 is assigned to a call to F4, that returns with no other function calls, then the subroutine can be represented at F3 as (F3,3 i.e., call function F3 then call subroutine 3, and assign a subroutine ID of 4). Similarly, the subroutine at F2 can be represented as (F2,4,4). Further improvement can be achieved by performing loop identification, which could be done through repeating patterns analysis. For example, subroutine at node F2 could be represented as (F2, 2×(4)), meaning F2 and two times subroutine ID 4, and so on.

An important feature of subroutine identification is that if a certain code path (function call chain) is exercised multiple times during the execution, then this will be represented as multiple instances of a subroutine with a single identifier, as is the case for subroutine with ID 4 in the example of FIG. 4.

Returning to FIG. 3, the fourth step is the subroutine performance determination, step 304. In this step, the performance of the subroutine is determined. One way to do this is to take the average execution duration of all instances of a subroutine as the performance of that subroutine. Another more advanced way assumes loop identification. In this approach, the performance of a subroutine is modeled in terms of the performance of its subroutines and the number of times each subroutine is executed. Other more advanced approaches are also possible for this step that take into account behavior of sequences of subroutines.

The solution relies on subroutines and their performances on the different hardware flavors to estimate the performance of an application. At the end of the training stage, a set of subroutines and their performance on the various hardware profiles is available. What this means is that benchmarking applications should be selected/developed such that they cover as many of the subroutines as possible that may be contained in future applications. This means that the applications should implement recommended development patterns that exercise the various functions of the framework. It should be noted, however, that it is impossible to cover all the possible subroutines for future applications and therefore, one goal is to cover most subroutines towards the leaves of the execution tree that often reside inside the framework libraries/modules.

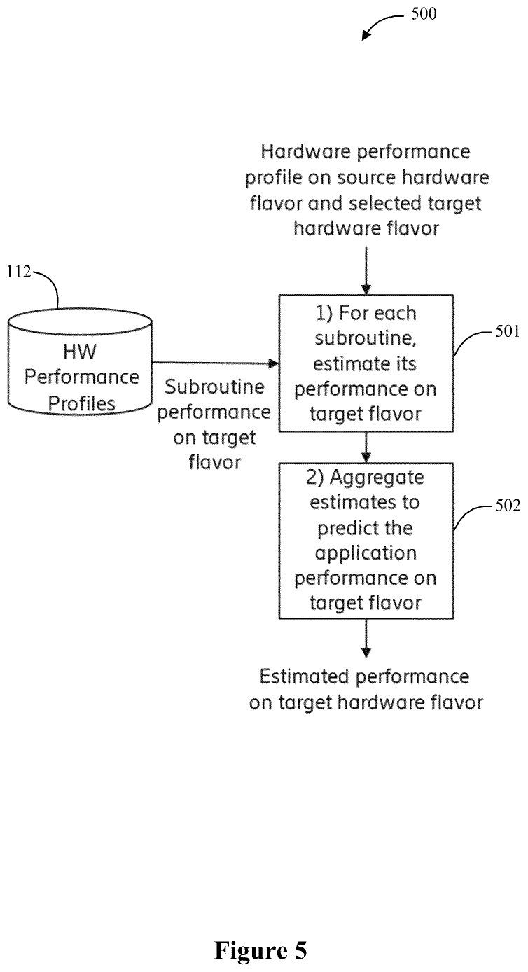

The inferencing phase is entered for each application for which performance needs to be estimated on a given hardware flavor. The inferencing phase uses the performance profile generator 201 (FIG. 2) to generate a profile for the application 101 (FIG. 1) on a single source hardware flavor (one of 103-105). This input is given to the performance estimator 202, which executes the overall steps shown in FIG. 5. If the estimate is needed for more than one target hardware flavor 103-105, the performance estimator 202 may be executed for each flavor using the same source performance profile, for example hardware performance profile 102, created by the performance profile generator 201. The steps for performance estimation 500 are explained in more detail below.

The method starts by estimating the performance of subroutines 501. In this step, the goal is to estimate the performance of the subroutines, identified in the source flavor, on the target flavors.

This can be done in two ways. In the first way, if a subroutine was already identified during the training phase, then the performance of that subroutine was stored in the hardware performance profiles 112 and the performance on the target flavor can be estimated. For the solution outlined above in the training phase (where the average execution duration of all instances of a subroutine are taken as the performance of that subroutine), the performance of the subroutine on the target flavor is calculated such that the ratio of the performance of the subroutine on the source to destination flavors determined during the training phase is equal to the ratio of the measured performance of the subroutine on the source flavor to that of the target flavor.

For example, for a given subroutine during training on hardware flavor 1 the average execution was 1 second and on hardware flavor 2 it was 2 seconds, then if for the application the measured average performance on flavor 1 is 2 seconds, it can be estimated that it will be 4 seconds for flavor 2.

In the second way, if a subroutine was not identified during the training phase, then its performance should be estimated. For each subroutine, the execution time of subroutines called can be distinguish from the pure execution time without called subroutines. One way to estimate the performance is to calculate the estimated execution period as the sum of the estimated execution periods of the called subroutines (i.e., recursively executing the first way and the second way) plus the time the top-level function of the subroutine takes excluding those of the invoked subroutines.

The second step is estimating, 502, the performance of the application on the target flavor as the aggregation of the estimate of the performance of the subroutines on the target flavor as determined in the previous step. This is done by considering the execution tree and performing an aggregation across the tree. As an example, assuming that the execution of the application on flavor 2 resulted in the execution tree depicted in FIG. 4. Assuming also that subroutines 2, 5 and 6 were not identified during the training phase. Finally, assuming that the performance of subroutines 1, 3 and 4 is determined to be 1 second, 2 seconds and 2.5 seconds respectively. Then the performance of subroutine 2 is estimated to be 1 second (equal to that of subroutine 1). The performance of subroutine 5 is estimated as 5 seconds (twice that of subroutine 4) and the performance of the application, which is the same as the performance of subroutine 6 is calculated as 6 seconds (i.e., the sum of that of subroutine 5 which is 5 seconds and that of 2 which is 1 second.)

Evaluation of the solution was done for a use-case. To simplify the presentation of the solution and explain the various concepts with specific examples, the solution is presented for a specific use-case of training machine learning models on different hardware flavors. For this use-case, it is assumed that the applications are written in Python using TensorFlow as the high-level framework for accessing acceleration capability supported by the underlying hardware. The performance metric of interest is the time it takes to train a machine learning model.

Results are presented next. The solution was implemented in the Python programming language. As applications, the training of two machine learning models were considered. The performance metric considered was the time it took to train those models.

As a benchmarking application, the ResNet50 network (Deep Residual Learning for Image Recognition, keras.io/api/applications/resnet/#resnet50-function) was used on the cifar100 dataset (Learning Multiple Layers of Features from Tiny Images, www.tensorflow.org/datasets/catalog/cifar100) which was trained for two epochs. Two hardware flavors were considered in the experiments. The first flavor was a Linux server with 30 CPU cores and 250 gigabytes of random-access memory with no GPU (flavor #1). The second flavor was the same type of server but with an NVIDIA A100-SXM4-80 GB GPU (flavor #2).

As a test application, the hand-written digit recognition model from Keras (François Chollet, Simple MNIST Convnet, keras.io/examples/vision/mnist_convnet/) was used and trained with the MINIST dataset (The MNIST Database of Handwritten Digits, keras.io/api/datasets/mnist/) for five epochs.

Table 1 summarizes the results of the profiling process for the benchmarking and test applications. The benchmarking application produced 2.3 times more events than the test application. Regarding acceleration, it can be seen that the benchmarking application was accelerated 29× while the test application only experienced an acceleration of 2.55×. Despite comparable numbers for the subroutines, it was found that for the same application, the subroutines identified were quite similar, 90% of the subroutines identified in the test application were also found in the benchmarking application.

The following table summarizes the results of the profiling process for the benchmarking and test applications.

TABLE 1
Evaluation results

| | Benchmarking application | | Test application | |
|---|---|---|---|---|
| | Flavor | | | |
| | flavor#1 | flavor#2 | flavor#1 | flavor#2 |
| Trace events | 14529210 | 14508370 | 5931646 | 5913732 |
| Performance | 2733.1 | 91.9 | 68.9 | 26.8 |
| (sec) | | | | |
| Functions | 12072 | 12072 | 12075 | 12075 |
| Subroutines | 46685 | 46696 | 46819 | 46830 |

Using the presented method, the performance of the test application was estimated on flavor #2 using the performance profiles of the benchmarking application on flavor #1 and flavor #2 as well as the profile of the test application on flavor #1. The solution gave an estimation of 19.13 seconds as the performance (vs. 26.8 seconds actual value) and an error of about 30%. This compares advantageously to a naïve solution that uses the ratio of performance of the benchmarking application on the two flavors (i.e., 30% vs 2974%).

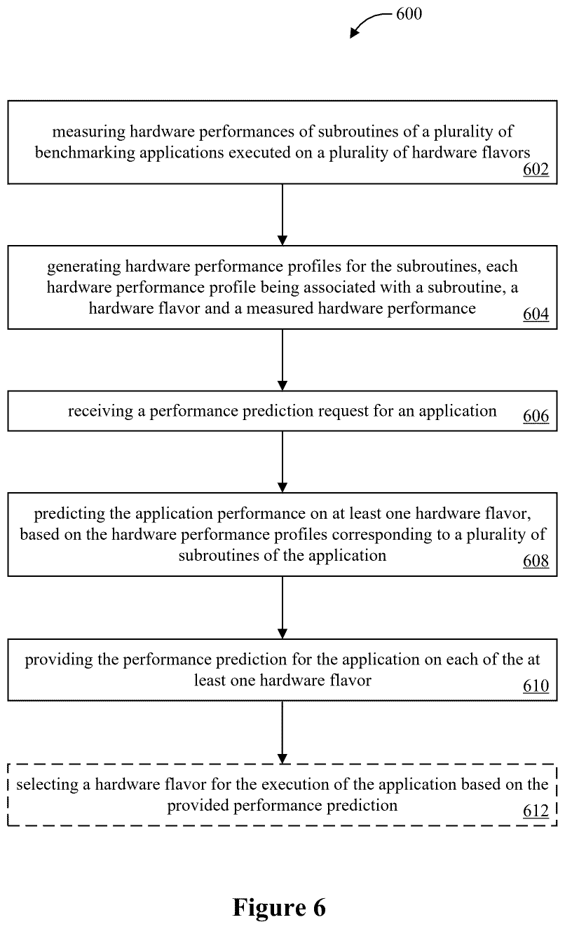

Turning to FIG. 6, there is provided a computer implemented method 600 for application performance prediction. The method comprises measuring, step 602, hardware performances of subroutines of a plurality of benchmarking applications executed on a plurality of hardware flavors. The method comprises generating, step 604, hardware performance profiles for the subroutines, each hardware performance profile being associated with a subroutine, a hardware flavor and a measured hardware performance. The method comprises receiving, step 606, a performance prediction request for an application. The method comprises predicting, step 608, the application performance on at least one hardware flavor, based on the hardware performance profiles corresponding to a plurality of subroutines of the application. The method comprises providing, step 610 the performance prediction for the application on each of the at least one hardware flavor.

A subroutine may be uniquely identified, and associated with a hardware performance profile, based on a trace associated with the subroutine. Measuring hardware performances of subroutines may comprise measuring execution times of the subroutines.

In the cases where the traces could provide further information than execution times, or if other information than execution time could be derived from the traces, the obtained hardware performance metric could be different than execution times. For instance, if the trace could provide the amount of compute resources used by each function call, then the hardware performances could be measured in terms of amount of compute resources used.

Each hardware performance profile may further comprise a subroutine execution time obtained by averaging measured hardware performances of the associated subroutine from the plurality of executed benchmarking applications. Each hardware performance profile may further comprise a subroutine execution time obtained from a machine learning model trained using measured hardware performances of the associated subroutine from the plurality of executed benchmarking applications.

Generating hardware performance profiles for the subroutines may further comprise harmonizing the hardware performance profiles for the subroutines of the benchmarking applications. Harmonizing can include removing duplicates, defining a naming convention to name equivalent hardware performance profiles or subroutines from different systems with a common name, data cleaning, etc. as would be apparent to a person skilled in the art.

Predicting the application performance may further comprise identifying the plurality of subroutines of the application based on application traces associated with the subroutines of the application. Identifying the plurality of subroutines may comprise building an execution tree for identifying the plurality of subroutines.

Predicting the application performance may comprise aggregating the subroutine execution time comprised in the hardware performance profile corresponding to each of the plurality of subroutines of the application.

The method may further comprise selecting, step 612, a hardware flavor for the execution of the application based on the provided performance prediction.

It should be noted that methods and steps described herein are, generally, computer implemented methods and steps. The term computer may be interpreted as having different meanings, such as explained next, for example.

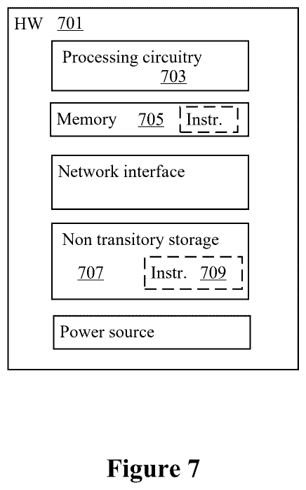

Referring to FIG. 7, there is provided an apparatus (HW) 701, in which functions and steps described herein can be implemented.

The apparatus 701 may be a server, network node, radio base station, or other computing device which may be part of a cloud computing system, edge computing system, or which may be a standalone device.

The apparatus 701, is operative to execute any of the steps described herein to enable selecting a hardware flavor on which an application can be executed. The selection is made based on past observations of execution of benchmark applications of the different hardware flavors and particularly observation of how the different subroutines of the benchmarking applications were executing on each hardware flavors. Based on an aggregation of a predicted/average performance of the subroutines of the application on the different hardware flavors, selection of a hardware flavor can be made for the execution of the application, which allows for better performance.

The apparatus 701 comprises processing circuitry 703 and memory 705. The memory 705 can contain instructions executable by the processing circuitry 703 whereby functions and steps described herein may be executed to provide any of the relevant features and benefits disclosed herein.

The apparatus 701 may also include non-transitory, persistent, machine-readable storage media 707 having stored therein software and/or instruction 709 executable by the processing circuitry 703 to execute functions and steps described herein. The apparatus may also include network interface(s) and a power source.

The instructions 709 may include a computer program for configuring the processing circuitry 703. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

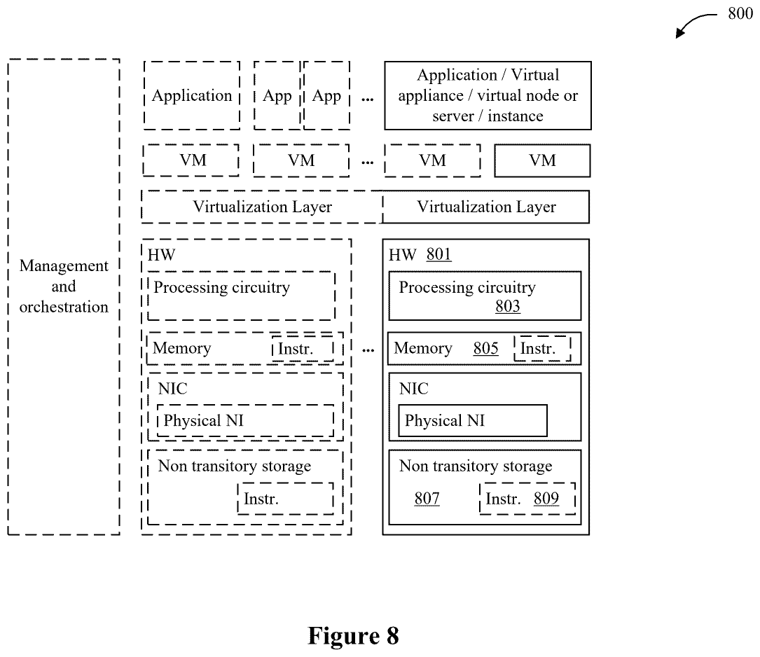

Referring to FIG. 8, there is provided a virtualization environment 800 in which functions and steps described herein can be implemented.

The virtualization environment 800 (which may go beyond what is illustrated in FIG. 8), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 801 comprising processing circuitry 803 and memory 805. The memory 805 can contain instructions executable by the processing circuitry 803 whereby functions and steps described herein may be executed to provide any of the relevant features and benefits disclosed herein.

The hardware 801 may also include non-transitory, persistent, machine-readable storage media 807 having stored therein software and/or instruction 809 executable by the processing circuitry 803 to execute functions and steps described herein.

The instructions 809 may include a computer program for configuring the processing circuitry 803. The computer program may be stored in a removable memory, such as a portable compact disc, portable digital video disc, or other removable media. The computer program may be stored in a physical memory local to the hardware 801, which can be removable, or it could alternatively, or in part, be stored in the cloud. The computer program may also be embodied in a carrier such as an electronic signal, optical signal, radio signal, or computer readable storage medium.

Referring again to FIGS. 7 and 8, there is provided an apparatus 701, 801 for application performance prediction. The apparatus comprises processing circuits 703, 803 and a memory 705, 805. The memory 705, 805 contains instructions executable by the processing circuits 703, 803 whereby the apparatus is operative to measure hardware performances of subroutines of a plurality of benchmarking applications executed on a plurality of hardware flavors. The apparatus is operative to generate hardware performance profiles for the subroutines, each hardware performance profile being associated with a subroutine, a hardware flavor and a measured hardware performance. The apparatus is operative to receive a performance prediction request for an application. The apparatus is operative to predict the application performance on at least one hardware flavor, based on the hardware performance profiles corresponding to a plurality of subroutines of the application. The apparatus is operative to provide the performance prediction for the application on each of the at least one hardware flavor.

The apparatus may be further operative to uniquely identify a subroutine, and to associate the subroutine with a hardware performance profile, based on a trace associated with the subroutine. The apparatus may be further operative to measure execution times of the subroutines.

Each hardware performance profile may further comprise a subroutine execution time obtained by averaging measured hardware performances of the associated subroutine from the plurality of executed benchmarking applications. Each hardware performance profile may further comprise a subroutine execution time obtained from a machine learning model trained using measured hardware performances of the associated subroutine from the plurality of executed benchmarking applications.

The apparatus may be further operative to harmonize the hardware performance profiles for the subroutines of the benchmarking applications.

The apparatus may be further operative to identify the plurality of subroutines of the application based on application traces associated with the subroutines of the application. The apparatus may be further operative to build an execution tree for identifying the plurality of subroutines.

The apparatus may be further operative to aggregate the subroutine execution time comprised in the hardware performance profile corresponding to each of the plurality of subroutines of the application.

The apparatus may be further operative to select a hardware flavor for the execution of the application based on the provided performance prediction.

Still referring to FIGS. 7 and 8 there is provided a non-transitory computer readable media 707, 807 having stored thereon instructions 709, 809 application performance prediction. The instructions comprise measuring hardware performances of subroutines of a plurality of benchmarking applications executed on a plurality of hardware flavors. The instructions comprise generating hardware performance profiles for the subroutines, each hardware performance profile being associated with a subroutine, a hardware flavor and a measured hardware performance. The instructions comprise receiving a performance prediction request for an application. The instructions comprise predicting the application performance on at least one hardware flavor, based on the hardware performance profiles corresponding to a plurality of subroutines of the application. The instructions comprise providing the performance prediction for the application on each of the at least one hardware flavor.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method for application performance prediction, comprising:
measuring hardware performances of subroutines of a plurality of benchmarking applications executed on a plurality of hardware flavors;
generating hardware performance profiles for the subroutines, each hardware performance profile being associated with a subroutine, a hardware flavor and a measured hardware performance;
receiving a performance prediction request for an application;
predicting the application performance on at least one hardware flavor, based on the hardware performance profiles corresponding to a plurality of subroutines of the application; and
providing the performance prediction for the application on each of the at least one hardware flavor.

2. The method of claim 1, wherein a subroutine is uniquely identified, and associated with a hardware performance profile, based on a trace associated with the subroutine.

3. The method of claim 1, wherein measuring hardware performances of subroutines comprises measuring execution times of the subroutines.

4. The method of claim 1, wherein each hardware performance profile further comprises a subroutine execution time obtained by averaging measured hardware performances of the associated subroutine from the plurality of executed benchmarking applications.

5. The method of claim 1, wherein each hardware performance profile further comprises a subroutine execution time obtained from a machine learning model trained using measured hardware performances of the associated subroutine from the plurality of executed benchmarking applications.

6. The method of claim 1, wherein generating hardware performance profiles for the subroutines further comprise harmonizing the hardware performance profiles for the subroutines of the benchmarking applications.

7. The method of claim 1, wherein predicting the application performance further comprises identifying the plurality of subroutines of the application based on application traces associated with the subroutines of the application.

8. The method of claim 7, wherein identifying the plurality of subroutines comprises building an execution tree for identifying the plurality of subroutines.

9. The method of claim 4, wherein predicting the application performance comprises aggregating the subroutine execution time comprised in the hardware performance profile corresponding to each of the plurality of subroutines of the application.

10. The method of claim 1, further comprising selecting a hardware flavor for the execution of the application based on the provided performance prediction.

11. An apparatus for application performance prediction comprising processing circuits and a memory, the memory containing instructions executable by the processing circuits whereby the apparatus is operative to:
measure hardware performances of subroutines of a plurality of benchmarking applications executed on a plurality of hardware flavors;
generate hardware performance profiles for the subroutines, each hardware performance profile being associated with a subroutine, a hardware flavor and a measured hardware performance;
receive a performance prediction request for an application;
predict the application performance on at least one hardware flavor, based on the hardware performance profiles corresponding to a plurality of subroutines of the application; and
provide the performance prediction for the application on each of the at least one hardware flavor.

12. The apparatus of claim 11, further operative to uniquely identify a subroutine, and to associate the subroutine with a hardware performance profile, based on a trace associated with the subroutine.

13. The apparatus of claim 11, further operative to measure execution times of the subroutines.

14. The apparatus of claim 11, wherein each hardware performance profile further comprises a subroutine execution time obtained by averaging measured hardware performances of the associated subroutine from the plurality of executed benchmarking applications.

15. The apparatus of claim 11, wherein each hardware performance profile further comprises a subroutine execution time obtained from a machine learning model trained using measured hardware performances of the associated subroutine from the plurality of executed benchmarking applications.

16. The apparatus of claim 11, further operative to harmonize the hardware performance profiles for the subroutines of the benchmarking applications.

17. The apparatus of claim 11, further operative to identify the plurality of subroutines of the application based on application traces associated with the subroutines of the application.

18. The apparatus of claim 17, further operative to build an execution tree for identifying the plurality of subroutines.

19. The apparatus of claim 14, further operative to aggregate the subroutine execution time comprised in the hardware performance profile corresponding to each of the plurality of subroutines of the application.

20. (canceled)

21. A non-transitory computer readable media having stored thereon instructions for application performance prediction, the instructions comprising:
measuring hardware performances of subroutines of a plurality of benchmarking applications executed on a plurality of hardware flavors;
generating hardware performance profiles for the subroutines, each hardware performance profile being associated with a subroutine, a hardware flavor and a measured hardware performance;
receiving a performance prediction request for an application;
predicting the application performance on at least one hardware flavor, based on the hardware performance profiles corresponding to a plurality of subroutines of the application; and
providing the performance prediction for the application on each of the at least one hardware flavor.
